(19) United States
(12) Patent Application Publication
(10) Pub. No.: US 2010/0160190 A1
(43) Pub. Date: Jun. 24, 2010

(54) WEATHERABLE COLORED RESINOUS COMPOSITION AND METHOD

(76) Inventors: Olga I. Kuvshinnikova, Glenmont, NY (US); Douglas W. Howie, JR., Parkersburg, WV (US)

Correspondence Address: SABIC Geloy, SABIC Innovative Plastics - IP Legal, 1 Plastics Avenue, Pittsfield, MA, 01201, US

(21) Appl. No.: 12/339,151

(22) Filed: Dec. 19, 2008

(51) Int. Cl. C10M 125/02; C08K 3/34; C08K 3/22; C08K 3/04; C10M 125/26

(52) U.S. Cl. 508/117; 524/449; 524/431; 523/351; 508/141

(57) ABSTRACT

Disclosed are weatherable compositions comprising (i) 25-45 wt. % of an acrylonitrile-styrene-acrylate graft copolymer (ASA) or acrylate-modified ASA, (ii) 75-55 wt. % of at least one rigid thermoplastic polymer comprising structural units derived from styrene and acrylonitrile; alpha-methylstyrene and acrylonitrile; alpha-methylstyrene, styrene, and acrylonitrile; styrene, acrylonitrile, and methyl methacrylate; alpha-methyl styrene, acrylonitrile, and methyl methacrylate; or alpha-methylstyrene, styrene, acrylonitrile, and methyl methacrylate, or mixtures thereof, (iii) at least one iron oxide-coated mica, and (iv) at least one organic or inorganic colorant. A process for making the compositions is also disclosed. Articles made from said compositions are also disclosed.

### BACKGROUND

The present invention relates to colored resinous compositions which exhibit good resistance to weathering. In particular embodiments the present invention relates to colored resinous compositions containing mica which exhibit good resistance to weathering.

It is known to produce a colored formed article by including an organic red colorant such as Solvent Red 135 in a resinous composition from which the formed article is derived. To achieve special visual effects in colored formed articles, micaceous pigments are often added to the resinous compositions. However, it has been observed that organic red colorant in the presence of certain micaceous pigments, such as a titanium oxide-coated mica, is not stable to weathering conditions, and undesirable discoloration is observed in formed articles comprising such compositions. When color is achieved by replacing organic red colorant with standard red iron oxide in such compositions, the color of formed articles is too dark and/or too dull for desired applications. There exists a need for colored resinous compositions which exhibit color stability in formed articles exposed to weathering conditions. In particular there exists a need for colored resinous compositions which exhibit color stability in formed articles exposed to weathering conditions.

### BRIEF DESCRIPTION

The present inventors have discovered novel compositions which exhibit color stability and good resistance to weathering while retaining stable color. In one embodiment the present invention comprises a weatherable, colored resinous composition comprising (i) 25-45 wt. % of an acrylonitrile-styrene-acrylate graft copolymer (ASA) or acrylate-modified ASA, (ii) 75-55 wt. % of at least one rigid thermoplastic polymer comprising structural units derived from styrene and acrylonitrile; alpha-methylstyrene and acrylonitrile; alpha-methylstyrene, styrene, and acrylonitrile; styrene, acrylonitrile, and methyl methacrylate; alpha-methyl styrene, acrylonitrile, and methyl methacrylate; or alpha-methylstyrene, styrene, acrylonitrile, and methyl methacrylate, or mixtures thereof, (iii) at least one iron oxide-coated mica, and (iv) at least one organic or inorganic secondary colorant, wherein the combined amounts of components (iii) and (iv) are those amounts effective to provide a formed article with a delta L* value of less than plus/minus 0.6 measured with specular component excluded and a delta E value of less than plus/minus 1.0 after exposure of the formed article to 2500 kilojoules per square meter under accelerated weathering conditions administered under the ASTM G155c protocol, and wherein wt. % values are based on the weight of resinous components (i) and (ii).

In another embodiment the present invention comprises a weatherable, colored resinous composition comprising (i) 25-45 wt. % of an acrylonitrile-styrene-acrylate graft copolymer (ASA) or acrylate-modified ASA, (ii) 75-55 wt. % of at least one rigid thermoplastic polymer comprising structural units derived from styrene, acrylonitrile, and methyl methacrylate, (iii) at least one iron oxide-coated mica present in an amount in a range of 0.1 parts per hundred parts resin (phr) and 10 phr, (iv) at least one organic secondary colorant and (v) at least one inorganic secondary colorant selected from the group consisting of iron(III) oxide, carbon black, titanium dioxide and mixtures thereof, wherein the combined amounts of components (iii), (iv) and (v) are those amounts effective to provide a formed article with a delta L* value of less than plus/minus 0.6 measured with specular component excluded and a delta E value of less than plus/minus 1.0 after exposure of the formed article to 2500 kilojoules per square meter under accelerated weathering conditions administered under the ASTM G155c protocol, and wherein wt. % values are based on the weight of resinous components (i) and (ii).

In still another embodiment the present invention comprises a process for preparing a weatherable, colored resinous composition comprising (i) 25-45 wt. % of an acrylonitrile-styrene-acrylate graft copolymer (ASA) or acrylate-modified ASA, (ii) 75-55 wt. % of at least one rigid thermoplastic polymer comprising structural units derived from styrene and acrylonitrile; alpha-methylstyrene and acrylonitrile; alpha-methylstyrene, styrene, and acrylonitrile; styrene, acrylonitrile, and methyl methacrylate; alpha-methyl styrene, acrylonitrile, and methyl methacrylate; or alpha-methylstyrene, styrene, acrylonitrile, and methyl methacrylate, or mixtures thereof, (iii) at least one iron oxide-coated mica, (iv) at least one organic secondary colorant and (v) at least one inorganic secondary colorant selected from the group consisting of iron(III) oxide, carbon black, titanium dioxide and mixtures thereof, wherein the combined amounts of components (iii), (iv) and (v) are those amounts effective to provide a formed article with a delta L* value of less than plus/minus 0.6 measured with specular component excluded and a delta E value of less than plus/minus 1.0 after exposure of the formed article to 2500 kilojoules per square meter under accelerated weathering conditions administered under the ASTM G155c protocol, and wherein wt. % values are based on the weight of resinous components (i) and (ii); which process comprises the steps of (A) preparing a masterbatch comprising all or a portion of mica component (iii) and at least a portion of the rigid thermoplastic polymer (ii), (B) combining the masterbatch with remaining compositional components in a compounding process, and (C) compounding the mixture.

In still other embodiments the present invention comprises articles made from said compositions. Various other features, aspects, and advantages of the present invention will become more apparent with reference to the following description and appended claims.

### DETAILED DESCRIPTION

In the following specification and the claims which follow, reference will be made to a number of terms which shall be defined to have the following meanings. The singular forms “a”, “an” and “the” include plural referents unless the context clearly dictates otherwise. The terminology “monoethylenically unsaturated” means having a single site of ethylenic unsaturation per molecule. The terminology “polyethylenically unsaturated” means having two or more sites of ethylenic unsaturation per molecule. The terminology “(meth)acrylate” refers collectively to acrylate and methacrylate; for example, the term “(meth)acrylate monomers” refers collectively to acrylate monomers and methacrylate monomers. The term “(meth)acrylamide” refers collectively to acrylamides and methacrylamides.

The term “alkyl” as used in the various embodiments of the present invention is intended to designate linear alkyl, branched alkyl, aralkyl, cycloalkyl, bicycloalkyl, tricycloalkyl and polycycloalkyl radicals containing carbon and hydrogen atoms, and optionally containing atoms in addition to carbon and hydrogen, for example atoms selected from Groups 15, 16 and 17 of the Periodic Table. Alkyl groups may be saturated or unsaturated, and may comprise, for example, vinyl or allyl. The term “alkyl” also encompasses that alkyl portion of alkoxide groups. In various embodiments normal and branched alkyl radicals are those containing from 1 to about 32 carbon atoms, and include as illustrative non-limiting examples C₁-C₃₂ alkyl (optionally substituted with one or more groups selected from C₁-C₃₂ alkyl, C₃-C₁₅ cycloalkyl or aryl); and C₃-C₁₅ cycloalkyl optionally substituted with one or more groups selected from C₁-C₃₂ alkyl. Some particular illustrative examples comprise methyl, ethyl, n-propyl, isopropyl, n-butyl, sec-butyl, tertiary-butyl, pentyl, neopentyl, hexyl, heptyl, octyl, nonyl, decyl, undecyl and dodecyl. Some illustrative non-limiting examples of cycloalkyl and bicycloalkyl radicals include cyclobutyl, cyclopentyl, cyclohexyl, methylcyclohexyl, cycloheptyl, bicycloheptyl and adamantyl. In various embodiments aralkyl radicals are those containing from 7 to about 14 carbon atoms; these include, but are not limited to, benzyl, phenylbutyl, phenylpropyl, and phenylethyl. The term “aryl” as used in the various embodiments of the present invention is intended to designate substituted or unsubstituted aryl radicals containing from 6 to 20 ring carbon atoms. Some illustrative non-limiting examples of these aryl radicals include C₆-C₂₀ aryl optionally substituted with one or more groups selected from C₁-C₃₂ alkyl, C₃-C₁₅ cycloalkyl, aryl, and functional groups comprising atoms selected from Groups 15, 16 and 17 of the Periodic Table. Some particular illustrative examples of aryl radicals comprise substituted or unsubstituted phenyl, biphenyl, tolyl, naphthyl and binaphthyl.

Compositions of the present invention comprise a rubber modified thermoplastic resin comprising a discontinuous elastomeric phase dispersed in a rigid thermoplastic phase, wherein at least a portion of the rigid thermoplastic phase is grafted to the elastomeric phase. The rubber modified thermoplastic resin employs at least one rubber substrate for grafting. The rubber substrate comprises the discontinuous elastomeric phase of the composition. There is no particular limitation on the rubber substrate provided it is susceptible to grafting by at least a portion of a graftable monomer. In some embodiments suitable rubber substrates comprise dimethyl siloxane/butyl acrylate rubber, or silicone/butyl acrylate composite rubber; polyolefin rubbers such as ethylene-propylene rubber or ethylene-propylene-diene (EPDM) rubber; or silicone rubber polymers such as polymethylsiloxane rubber. The rubber substrate typically has a glass transition temperature, Tg, in one embodiment less than or equal to 25° C., in another embodiment below about 0° C., in another embodiment below about minus 20° C., and in still another embodiment below about minus 30° C. As referred to herein, the Tg of a polymer is determined by differential scanning calorimetry (DSC; heating rate 20° C./minute, with the Tg value being determined at the inflection point).

In one embodiment the rubber substrate is derived from polymerization by known methods of at least one monoethylenically unsaturated alkyl(meth)acrylate monomer selected from (C₁-C₁₂)alkyl(meth)acrylate monomers and mixtures comprising at least one of said monomers. As used herein, the terminology “(Cₓ-C_{y})”, as applied to a particular unit, such as, for example, a chemical compound or a chemical substituent group, means having a carbon atom content of from “x” carbon atoms to “y” carbon atoms per such unit. For example, “(C₁-C₁₂)alkyl” means a straight chain, branched or cyclic alkyl substituent group having from 1 to 12 carbon atoms per group. Suitable (C₁-C₁₂)alkyl(meth)acrylate monomers include, but are not limited to, (C₁-C₁₂)alkyl acrylate monomers, illustrative examples of which comprise ethyl acrylate, butyl acrylate, iso-pentyl acrylate, n-hexyl acrylate, and 2-ethyl hexyl acrylate; and their (C₁-C₁₂)alkyl methacrylate analogs, illustrative examples of which comprise methyl methacrylate, ethyl methacrylate, propyl methacrylate, iso-propyl methacrylate, butyl methacrylate, hexyl methacrylate, and decyl methacrylate. In a particular embodiment of the present invention the rubber substrate comprises structural units derived from n-butyl acrylate.

In various embodiments the rubber substrate may also optionally comprise a minor amount, for example up to about 5 wt. %, of structural units derived from at least one polyethylenically unsaturated monomer, for example those that are copolymerizable with a monomer used to prepare the rubber substrate. A polyethylenically unsaturated monomer is often employed to provide cross-linking of the rubber particles and/or to provide “graftlinking” sites in the rubber substrate for subsequent reaction with grafting monomers. Suitable polyethylenically unsaturated monomers include, but are not limited to, butylene diacrylate, divinyl benzene, butene diol dimethacrylate, trimethylolpropane tri(meth)acrylate, allyl methacrylate, diallyl methacrylate, diallyl maleate, diallyl fumarate, diallyl phthalate, triallyl methacrylate, triallyl cyanurate, triallyl isocyanurate, the acrylate of tricyclodecenylalcohol and mixtures comprising at least one of such monomers. In a particular embodiment the rubber substrate comprises structural units derived from triallyl cyanurate.

In some embodiments the rubber substrate may optionally comprise structural units derived from minor amounts of other unsaturated monomers, for example those that are copolymerizable with a monomer used to prepare the rubber substrate. In particular embodiments the rubber substrate may optionally include up to about 25 wt. % of structural units derived from one or more monomers selected from (meth)acrylate monomers, alkenyl aromatic monomers and monoethylenically unsaturated nitrile monomers. Suitable copolymerizable (meth)acrylate monomers include, but are not limited to, C₁-C₁₂ aryl or haloaryl substituted acrylate, C₁-C₁₂ aryl or haloaryl substituted methacrylate, or mixtures thereof, monoethylenically unsaturated carboxylic acids, such as, for example, acrylic acid, methacrylic acid and itaconic acid; glycidyl(meth)acrylate, hydroxy alkyl(meth)acrylate, hydroxy(C₁-C₁₂)alkyl(meth)acrylate, such as, for example, hydroxyethyl methacrylate; (C₄-C₁₂)cycloalkyl(meth)acrylate monomers, such as, for example, cyclohexyl methacrylate; (meth)acrylamide monomers, such as, for example, acrylamide, methacrylamide and N-substituted-acrylamide or N-substituted-methacrylamides; maleimide monomers, such as, for example, maleimide, N-alkyl maleimides, N-aryl maleimides, N-phenyl maleimide, and haloaryl substituted maleimides; maleic anhydride; methyl vinyl ether, ethyl vinyl ether, and vinyl esters, such as, for example, vinyl acetate and vinyl propionate. Suitable alkenyl aromatic monomers include, but are not limited to, vinyl aromatic monomers, such as, for example, styrene and substituted styrenes having one or more alkyl, alkoxy, hydroxy or halo substituent groups attached to the aromatic ring, including, but not limited to, alpha-methyl styrene, p-methyl styrene, 3,5-diethylstyrene, 4-n-propylstyrene, 4-isopropylstyrene, vinyl toluene, alpha-methyl vinyl toluene, vinyl xylene, trimethyl styrene, butyl styrene, t-butyl styrene, chlorostyrene, alpha-chlorostyrene, dichlorostyrene, tetrachlorostyrene, bromostyrene, alpha-bromostyrene, dibromostyrene, p-hydroxystyrene, p-acetoxystyrene, methoxystyrene and vinyl-substituted condensed aromatic ring structures, such as, for example, vinyl naphthalene, vinyl anthracene, as well as mixtures of vinyl aromatic monomers and monoethylenically unsaturated nitrile monomers such as, for example, acrylonitrile, ethacrylonitrile, methacrylonitrile, alpha-bromoacrylonitrile and alpha-chloro acrylonitrile. Substituted styrenes with mixtures of substituents on the aromatic ring are also suitable. As used herein, the term “monoethylenically unsaturated nitrile monomer” means an acyclic compound that includes a single nitrile group and a single site of ethylenic unsaturation per molecule and includes, but is not limited to, acrylonitrile, methacrylonitrile, alpha-chloro acrylonitrile, and the like.

In a particular embodiment the rubber substrate comprises repeating units derived from one or more (C₁-C₁₂)alkyl acrylate monomers. In still another particular embodiment, the rubber substrate comprises from 40 to 95 wt. % repeating units derived from one or more (C₁-C₁₂)alkyl acrylate monomers, and more particularly from one or more monomers selected from ethyl acrylate, butyl acrylate and n-hexyl acrylate.

The rubber substrate may be present in the rubber modified thermoplastic resin in one embodiment at a level of from about 4 wt. % to about 94 wt. %; in another embodiment at a level of from about 10 wt. % to about 80 wt. %; in another embodiment at a level of from about 15 wt. % to about 80 wt. %; in another embodiment at a level of from about 35 wt. % to about 80 wt. %; in another embodiment at a level of from about 40 wt. % to about 80 wt. %; in another embodiment at a level of from about 25 wt. % to about 60 wt. %, and in still another embodiment at a level of from about 40 wt. % to about 50 wt. %, based on the weight of the rubber modified thermoplastic resin. In other embodiments the rubber substrate may be present in the rubber modified thermoplastic resin at a level of from about 5 wt. % to about 50 wt. %; at a level of from about 8 wt. % to about 40 wt. %; or at a level of from about 10 wt. % to about 30 wt. %, based on the weight of the particular rubber modified thermoplastic resin.

There is no particular limitation on the particle size distribution of the rubber substrate (sometimes referred to hereinafter as initial rubber substrate to distinguish it from the rubber substrate following grafting). In some embodiments the initial rubber substrate may possess a broad, essentially monomodal, particle size distribution with particles ranging in size from about 50 nanometers (nm) to about 1000 nm. In other embodiments the mean particle size of the initial rubber substrate may be less than about 100 nm. In still other embodiments the mean particle size of the initial rubber substrate may be in a range of between about 80 nm and about 400 nm. In other embodiments the mean particle size of the initial rubber substrate may be greater than about 400 nm. In still other embodiments the mean particle size of the initial rubber substrate may be in a range of between about 400 nm and about 750 nm. In still other embodiments the initial rubber substrate comprises particles which are a mixture of particle sizes with at least two mean particle size distributions. In a particular embodiment the initial rubber substrate comprises a mixture of particle sizes with each mean particle size distribution in a range of between about 80 nm and about 750 nm. In another particular embodiment the initial rubber substrate comprises a mixture of particle sizes, one with a mean particle size distribution in a range of between about 80 nm and about 400 nm; and one with a broad and essentially monomodal mean particle size distribution.

The rubber substrate may be made according to known methods, such as, but not limited to, a bulk, solution, or emulsion process. In one non-limiting embodiment the rubber substrate is made by aqueous emulsion polymerization in the presence of a free radical initiator, e.g., an azonitrile initiator, an organic peroxide initiator, a persulfate initiator or a redox initiator system, and, optionally, in the presence of a chain transfer agent, e.g., an alkyl mercaptan, to form particles of rubber substrate.

The rigid thermoplastic resin phase of the rubber modified thermoplastic resin comprises one or more thermoplastic polymers. In one embodiment of the present invention monomers are polymerized in the presence of the rubber substrate to thereby form a rigid thermoplastic phase, at least a portion of which is chemically grafted to the elastomeric phase. The portion of the rigid thermoplastic phase chemically grafted to rubber substrate is sometimes referred to hereinafter as grafted copolymer. The rigid thermoplastic phase comprises a thermoplastic polymer or copolymer that exhibits a glass transition temperature (Tg) in one embodiment of greater than about 25° C., in another embodiment of greater than or equal to 90° C., and in still another embodiment of greater than or equal to 100° C.

In a particular embodiment the rigid thermoplastic phase comprises a polymer having structural units derived from one or more monomers selected from the group consisting of (C₁-C₁₂)alkyl-(meth)acrylate monomers, aryl-(meth)acrylate monomers, alkenyl aromatic monomers and monoethylenically unsaturated nitrile monomers. Suitable (C₁-C₁₂)alkyl-(meth)acrylate and aryl-(meth)acrylate monomers, alkenyl aromatic monomers and monoethylenically unsaturated nitrile monomers include those set forth hereinabove in the description of the rubber substrate. In addition, the rigid thermoplastic resin phase may, provided that the Tg limitation for the phase is satisfied, optionally include up to about 10 wt. % of third repeating units derived from one or more other copolymerizable monomers.

The rigid thermoplastic phase typically comprises one or more alkenyl aromatic polymers. Suitable alkenyl aromatic polymers comprise at least about 20 wt. % structural units derived from one or more alkenyl aromatic monomers. In one embodiment the rigid thermoplastic phase comprises an alkenyl aromatic polymer having structural units derived from one or more alkenyl aromatic monomers and from one or more monoethylenically unsaturated nitrile monomers. Examples of such alkenyl aromatic polymers include, but are not limited to, styrene/acrylonitrile copolymers, alpha-methylstyrene/acrylonitrile copolymers, or alpha-methylstyrene/styrene/acrylonitrile copolymers. In another particular embodiment the rigid thermoplastic phase comprises an alkenyl aromatic polymer having structural units derived from one or more alkenyl aromatic monomers; from one or more monoethylenically unsaturated nitrile monomers; and from one or more monomers selected from the group consisting of (C₁-C₁₂)alkyl- and aryl-(meth)acrylate monomers. Examples of such alkenyl aromatic polymers include, but are not limited to, styrene/acrylonitrile/methyl methacrylate copolymers, alpha-methylstyrene/acrylonitrile/methyl methacrylate copolymers and alpha-methylstyrene/styrene/acrylonitrile/methyl methacrylate copolymers. Further examples of suitable alkenyl aromatic polymers comprise styrene/methyl methacrylate copolymers, styrene/maleic anhydride copolymers; styrene/acrylonitrile/maleic anhydride copolymers, and styrene/acrylonitrile/acrylic acid copolymers. These copolymers may be used for the rigid thermoplastic phase either individually or as mixtures.

When structural units in copolymers are derived from one or more monoethylenically unsaturated nitrile monomers, then the amount of nitrile monomer added to form the copolymer comprising the grafted copolymer and the rigid thermoplastic phase may be in one embodiment in a range of between about 5 wt. % and about 40 wt. %, in another embodiment in a range of between about 5 wt. % and about 30 wt. %, in another embodiment in a range of between about 10 wt. % and about 30 wt. %, and in yet another embodiment in a range of between about 15 wt. % and about 30 wt. %, based on the total weight of monomers added to form the copolymer comprising the grafted copolymer and the rigid thermoplastic phase.

When structural units in copolymers are derived from one or more (C₁-C₁₂)alkyl- and aryl-(meth)acrylate monomers, then the amount of the said monomer added to form the copolymer comprising the grafted copolymer and the rigid thermoplastic phase may be in one embodiment in a range of between about 5 wt. % and about 50 wt. %, in another embodiment in a range of between about 5 wt. % and about 45 wt. %, in another embodiment in a range of between about 10 wt. % and about 35 wt. %, and in yet another embodiment in a range of between about 15 wt. % and about 35 wt. %, based on the total weight of monomers added to form the copolymer comprising the grafted copolymer and the rigid thermoplastic phase.

The amount of grafting that takes place between the rubber substrate and monomers comprising the rigid thermoplastic phase varies with the relative amount and composition of the rubber phase. In one embodiment, greater than about 10 wt. % of the rigid thermoplastic phase is chemically grafted to the rubber substrate, based on the total amount of rigid thermoplastic phase in the composition. In another embodiment, greater than about 15 wt. % of the rigid thermoplastic phase is chemically grafted to the rubber substrate, based on the total amount of rigid thermoplastic phase in the composition. In still another embodiment, greater than about 20 wt. % of the rigid thermoplastic phase is chemically grafted to the rubber substrate, based on the total amount of rigid thermoplastic phase in the composition. In particular embodiments the amount of rigid thermoplastic phase chemically grafted to the rubber substrate may be in a range of between about 5 wt. % and about 90 wt. %; between about 10 wt. % and about 90 wt. %; between about 15 wt. % and about 85 wt. %; between about 15 wt. % and about 50 wt. %; or between about 20 wt. % and about 50 wt. %, based on the total amount of rigid thermoplastic phase in the composition. In yet other embodiments, about 40 wt. % to 90 wt. % of the rigid thermoplastic phase is free, that is, non-grafted.

The rigid thermoplastic phase may be present in the rubber modified thermoplastic resin in one embodiment at a level of from about 85 wt. % to about 6 wt. %; in another embodiment at a level of from about 65 wt. % to about 6 wt. %; in another embodiment at a level of from about 60 wt. % to about 20 wt. %; in another embodiment at a level of from about 75 wt. % to about 40 wt. %, and in still another embodiment at a level of from about 60 wt. % to about 50 wt. %, based on the weight of the rubber modified thermoplastic resin. In other embodiments the rigid thermoplastic phase may be present in a range of between about 90 wt. % and about 30 wt. %, based on the weight of the rubber modified thermoplastic resin.

In one embodiment two or more different rubber substrates, each possessing a different mean particle size, may be separately employed in a polymerization reaction to prepare rigid thermoplastic phase, and then the products blended together to make the rubber modified thermoplastic resin. In illustrative embodiments wherein such products each possessing a different mean particle size of initial rubber substrate are blended together, then the ratios of said substrates may be in a range of about 90:10 to about 10:90, or in a range of about 80:20 to about 20:80, or in a range of about 70:30 to about 30:70. In some embodiments an initial rubber substrate with smaller particle size is the major component in such a blend containing more than one particle size of initial rubber substrate.

The rigid thermoplastic phase may be made according to known processes, for example, mass polymerization, emulsion polymerization, suspension polymerization or combinations thereof, wherein at least a portion of the rigid thermoplastic phase is chemically bonded, i.e., “grafted” to the rubber phase via reaction with unsaturated sites present in the rubber phase. The grafting reaction may be performed in a batch, continuous or semi-continuous process. Representative procedures include, but are not limited to, those taught in U.S. Pat. No. 3,944,631. The unsaturated sites in the rubber phase are provided, for example, by residual unsaturated sites in those structural units of the rubber that were derived from a graftlinking monomer. In some embodiments of the present invention monomer grafting to rubber substrate with concomitant formation of rigid thermoplastic phase may optionally be performed in stages wherein at least one first monomer is grafted to rubber substrate followed by at least one second monomer different from said first monomer. Representative procedures for staged monomer grafting to rubber substrate include, but are not limited to, those taught in commonly assigned U.S. Pat. No. 7,049,368.

In a particular embodiment the rubber modified thermoplastic resin is an acrylonitrile-styrene-acrylate (ASA) graft copolymer such as that manufactured and sold by SABIC Innovative Plastics™ under the trademark GELOY®, and particularly an acrylate-modified ASA graft copolymer. ASA graft copolymers include, for example, those disclosed in U.S. Pat. No. 3,711,575. ASA graft copolymers also comprise those described in U.S. Pat. Nos. 4,731,414 and 4,831,079. In some embodiments of the invention where an acrylate-modified ASA is used, the ASA component further comprises an additional acrylate-graft formed from monomers selected from the group consisting of C₁-C₁₂ alkyl- and aryl-(meth)acrylate as part of either the rigid phase, the rubber phase, or both. Such copolymers are referred to as acrylate-modified acrylonitrile-styrene-acrylate graft copolymers, or acrylate-modified ASA. A particular monomer is methyl methacrylate to result in a PMMA-modified ASA (sometimes referred to hereinafter as “MMA-ASA”). In the context of the present invention the term “ASA” refers to both an acrylonitrile-styrene-acrylate graft copolymer (ASA) and an acrylate-modified ASA.

The rubber modified thermoplastic resin is present in compositions of the invention in an amount in one embodiment in a range of between about 5 wt. % and about 90 wt. %, in another embodiment in a range of between about 10 wt. % and about 80 wt. %, in another embodiment in a range of between about 10 wt. % and about 70 wt. %, in another embodiment in a range of between about 15 wt. % and about 65 wt. %, in still another embodiment in a range of between about 20 wt. % and about 65 wt. %, in still another embodiment in a range of between about 25 wt. % and about 45 wt. %, and in still another embodiment in a range of between about 30 wt. % and about 40 wt. %, based on the weight of resinous components in the composition.

The rigid thermoplastic phase of the rubber modified thermoplastic resin may comprise rigid thermoplastic phase present as a result of polymerization carried out in the presence of rubber substrate, or present as a result of addition of one or more separately synthesized rigid thermoplastic polymers to the rubber modified thermoplastic resin comprising the composition, or present as a result of a combination of both processes. In various embodiments compositions of the invention comprise a separately synthesized rigid thermoplastic resinous polymer comprising structural units derived from a mixture of at least one alkenyl aromatic monomer and at least one monoethylenically unsaturated nitrile monomer. Suitable alkenyl aromatic monomers include, but are not limited to, vinyl aromatic monomers, such as, for example, styrene and substituted styrenes having one or more alkyl, alkoxy, hydroxy or halo substituent groups attached to the aromatic ring, including, but not limited to, alpha-methyl styrene, p-methyl styrene, 3,5-diethylstyrene, 4-n-propylstyrene, 4-isopropylstyrene, vinyl toluene, alpha-methyl vinyl toluene, vinyl xylene, trimethyl styrene, butyl styrene, t-butyl styrene, chlorostyrene, alpha-chlorostyrene, dichlorostyrene, tetrachlorostyrene, bromostyrene, alpha-bromostyrene, dibromostyrene, p-hydroxystyrene, p-acetoxystyrene, methoxystyrene and vinyl-substituted condensed aromatic ring structures, such as, for example, vinyl naphthalene, vinyl anthracene. Substituted styrenes with mixtures of substituents on the aromatic ring are also suitable. As used herein, the term “monoethylenically unsaturated nitrile monomer” means an acyclic compound that includes a single nitrile group and a single site of ethylenic unsaturation per molecule and includes, but is not limited to, acrylonitrile, methacrylonitrile, ethacrylonitrile, alpha-chloroacrylonitrile, alpha-bromoacrylonitrile, and the like. In some embodiments the separately synthesized rigid thermoplastic polymer comprises structural units essentially identical to those of the rigid thermoplastic phase comprising the rubber modified thermoplastic resin. In some particular embodiments the separately synthesized rigid thermoplastic polymer comprises structural units derived from styrene and acrylonitrile; alpha-methylstyrene and acrylonitrile; alpha-methylstyrene, styrene, and acrylonitrile; styrene, acrylonitrile, and methyl methacrylate; alpha-methyl styrene, acrylonitrile, and methyl methacrylate; or alpha-methylstyrene, styrene, acrylonitrile, and methyl methacrylate, or the like or mixtures thereof. In one particular embodiment the separately synthesized rigid thermoplastic polymer comprises structural units derived from styrene, acrylonitrile, and methyl methacrylate (herein after sometimes abbreviated as MMASAN). Separately synthesized rigid thermoplastic polymer is present in compositions of the invention in an amount in one embodiment in a range of between about 10 wt. % and about 95 wt. %, in another embodiment in a range of between about 20 wt. % and about 90 wt. %, in another embodiment in a range of between about 30 wt. % and about 90 wt. %, in another embodiment in a range of between about 35 wt. % and about 85 wt. %, in still another embodiment in a range of between about 35 wt. % and about 80 wt. %, in still another embodiment in a range of between about 55 wt. % and about 75 wt. %, and in still another embodiment in a range of between about 60 wt. % and about 70 wt. %, based on the weight of resinous components in the composition.

Compositions in embodiments of the invention comprise iron oxide-coated mica. Mixtures of different types of iron oxide-coated mica may be employed. Iron oxide-coated mica may comprise mixed oxide-coated mica for example, mica coated with iron oxide and titanium dioxide. Illustrative examples of iron oxide-coated mica include, but are not limited to, IRIODIN® 500-type iron oxide-coated micas available from Merck, such as IRIODIN® types: 500, 502, 504, 505, 507, 520, 522, 524, 530, 532 and 534; IRIODIN® 300-type iron oxide-coated micas available from Merck, such as IRIODIN® types: 300, 302, 303, 306, 309, 320, 323, 351 and 355; KD-400-type iron oxide-coated micas available from Kodia Company Limited such as KD types: 401, 402, 403, 404, 405 and 406; and SunPEARL® iron oxide-coated micas available from Sun Chemical Performance Pigments. Other, illustrative iron oxide-coated micas are taught in U.S. Pat. Nos. 4,146,403, 4744832 and 5,759,255. Compositions of the invention typically comprise an amount of iron oxide-coated mica sufficient to provide a desired color in formed articles of the compositions. Representative desired colors include but are not limited to copper, bronze, gold, red-gold, and shades of red. In various embodiments compositions of the invention comprise an amount of iron oxide-coated mica in one embodiment in a range of between about 0.1 parts per hundred parts resin (phr) and about 10 phr, in another embodiment in a range of between about 0.3 phr and about 6 phr, and in still another embodiment in a range of between about 0.5 phr and about 4 phr. The amount of iron oxide-coated mica in compositions of the invention is that amount effective to provide a formed article with a delta L* value (measured with specular component excluded) in one embodiment of less than about plus/minus 0.6 and in another embodiment of less than about plus/minus 0.5 after 2500 kilojoules per square meter exposure under accelerated weathering conditions administered under the ASTM G155c protocol. In still other particular embodiments the amount of iron oxide-coated mica in compositions of the invention is that amount effective to provide a formed article with a delta E value in one embodiment of less than about plus/minus 1.0 and in another embodiment of less than about plus/minus 0.8 after 2500 kilojoules per square meter exposure under accelerated weathering conditions administered under the ASTM G155c protocol.

In various embodiments compositions of the invention comprise secondary colorants such as dyes and pigments which may be organic, inorganic or organometallic. Illustrative secondary colorants are not particularly limited and comprise those which either contribute to or do not inhibit the production of color provided by iron oxide-coated mica in formed articles of the compositions. Suitable secondary colorants may be employed either alone or as mixtures comprising more than one colorant in embodiments of compositions of the invention. In some particular embodiments at least two organic secondary colorants may be employed. In other particular embodiments at least one organic secondary colorant and at least one inorganic secondary colorant may be employed. In still other particular embodiments at least two organic secondary colorants and at least one inorganic secondary colorant may be employed. Illustrative organic secondary colorants may include, but are not limited to, those derived from the class of anthraquinone, anthracene, azo, phthalic anhydride, phthalocyanine, indigo/thioindigo, azomethine, azomethine-azo, dioxazine, quinacridone, coumarin, pyrazolone, quinophtalone, isoindolinone, isoindoline, diketopyrrolopyrrole, imidazole, naphtalimide, xanthene, thioxanthene, azine, rhodamine, perylene or perinone organic colorants, or the like or mixtures thereof. Illustrative inorganic secondary colorants include, but are not limited to, carbon black, titanium dioxide, iron oxide, chromium oxide, composite oxide, or the like or mixtures thereof. In other particular embodiments compositions of the invention comprise one of or both of titanium dioxide and carbon black. Some examples of secondary colorants include, but are not limited to, Solvent Yellow 93, Solvent Yellow 163, Solvent Yellow 114/Disperse Yellow 54, Solvent Violet 36, Solvent Violet 13, Solvent Red 195, Solvent Red 179, Solvent Red 135, Solvent Orange 60, Solvent Green 3, Solvent Blue 97, Solvent Blue 104, Solvent Blue 101, Macrolex Yellow E2R, Disperse Yellow 201, Disperse Red 60, Diaresin Red K, Colorplast Red LB, Pigment Yellow 183, Pigment Yellow 138, Pigment Yellow 110, Pigment Violet 29, Pigment Red 209, Pigment Red 209, Pigment Red 202, Pigment Red 178, Pigment Red 149, Pigment Red 104, Pigment Red 108, Pigment Red 29, Pigment Red 122, Pigment Orange 68, Pigment Green 7, Pigment Green 36, Pigment Blue 60, Pigment Blue 15:4, Pigment Blue 15:3, Pigment Yellow 53, Pigment Yellow 184, Pigment Yellow 119, Pigment White 6, Pigment Red 101, Pigment Green 50, Pigment Green 17, Pigment Brown 24, Pigment Blue 29, Pigment Blue 28, Pigment Black 7, lead molybdates, lead chromates, cerium sulfides, cadmium sulfoselenide, cadmium sulfide, and the like and mixtures thereof. In the present context secondary colorants as described herein above are separate and different from iron oxide-coated mica.

The amounts of secondary colorants in embodiments of compositions of the invention are not particularly limited and are typically those amounts effective to either contribute to or not inhibit the production of color provided by iron oxide-coated mica in formed articles of the compositions. In some embodiments the amounts of secondary colorants in compositions of the invention are those amounts effective to provide a formed article with a delta L* value (measured with specular component excluded) in one embodiment of less than about plus/minus 0.6 and in another embodiment of less than about plus/minus 0.5 after 2500 kilojoules per square meter exposure under accelerated weathering conditions administered under the ASTM G155c protocol. In other particular embodiments the amounts of secondary colorants in compositions of the invention are those amounts effective to provide a formed article with a delta E value in one embodiment of less than about plus/minus 1.0 and in another embodiment of less than about plus/minus 0.8 after 2500 kilojoules per square meter exposure under accelerated weathering conditions administered under the ASTM G155c protocol. In various embodiments the total amount of one or more secondary colorants present in compositions of the invention is in a range of between 0.1 phr and 10 phr. In various embodiments the total amount of secondary colorant present is less than or equal to about 4 phr, particularly less than or equal to about 3 phr and more particularly less than or equal to about 2 phr. In the present context the amount of secondary colorant present as described herein above is separate from that amount of iron oxide-coated mica present. In some particular embodiments of the invention formed articles are provided which exhibit a desired color primarily due to the presence of iron oxide-coated mica without the need to include a separate secondary red colorant.

Compositions of the present invention may also optionally comprise additives known in the art including, but not limited to, stabilizers, such as color stabilizers, heat stabilizers, light stabilizers, antioxidants, UV screeners, and UV absorbers; lubricants, flow promoters and other processing aids; plasticizers, antistatic agents, mold release agents, impact modifiers, fillers, and like additives. Illustrative additives include, but are not limited to, silica, silicates, zeolites, stone powder, glass fibers or spheres, carbon fibers, graphite, mica, calcium carbonate, talc, lithopone, zinc oxide, zirconium silicate, iron oxides, diatomaceous earth, calcium carbonate, magnesium oxide, chromic oxide, zirconium oxide, aluminum oxide, crushed quartz, clay, calcined clay, talc, kaolin, asbestos, cellulose, wood flour, cork, cotton and synthetic textile fibers, especially reinforcing fillers such as glass fibers, carbon fibers, metal fibers, and metal flakes, including, but not limited to aluminum flakes. Often more than one additive is included in compositions of the invention, and in some embodiments more than one additive of one type is included. In a particular embodiment a composition of the invention further comprises an additive selected from the group consisting of lubricants, stabilizers, heat stabilizers, light stabilizers, antioxidants, UV screeners, UV absorbers, and mixtures thereof.

The manner of combining one or more components with other components in compositions is not particularly critical in embodiments of the present invention. In some embodiments all or a portion of a component may be combined in essentially undiluted form with other composition components. In other embodiments all or a portion of a non-resinous component may be precompounded with at least a portion of one or more resinous components to prepare a masterbatch, and then remaining resinous component may be added and mixed therewith later, in some embodiments along with other resinous and non-resinous components. In particular embodiments all or a portion of one or more additives such as iron oxide-coated mica or one or more colorants or both and/or all or a portion of one or more conventional additives may optionally be present in any masterbatch. In some embodiments the masterbatch is prepared in an extrusion process. In one particular embodiment a masterbatch comprises iron oxide-coated mica and at least one resinous component, and the amount of iron oxide-coated mica in the masterbatch is in one embodiment in a range of 10-70 wt. %, and in another embodiment in a range of 20-60 wt. %, based on the weight of the masterbatch. In another particular embodiment a masterbatch comprises iron oxide-coated mica and at least one rigid thermoplastic polymer comprising structural units derived from styrene and acrylonitrile; alpha-methylstyrene and acrylonitrile; alpha-methylstyrene, styrene, and acrylonitrile; styrene, acrylonitrile, and methyl methacrylate; alpha-methyl styrene, acrylonitrile, and methyl methacrylate; or alpha-methylstyrene, styrene, acrylonitrile, and methyl methacrylate, or the like, or mixtures thereof. In one particular embodiment the invention encompasses a process for preparing a weatherable, colored resinous composition comprising (i) 25-45 wt. % of an acrylonitrile-styrene-acrylate graft copolymer (ASA) or acrylate-modified ASA, (ii) 75-55 wt. % of at least one rigid thermoplastic polymer comprising structural units derived from styrene and acrylonitrile; alpha-methylstyrene and acrylonitrile; alpha-methylstyrene, styrene, and acrylonitrile; styrene, acrylonitrile, and methyl methacrylate; alpha-methyl styrene, acrylonitrile, and methyl methacrylate; or alpha-methylstyrene, styrene, acrylonitrile, and methyl methacrylate, or mixtures thereof, (iii) at least one iron oxide-coated mica, (iv) at least one organic secondary colorant and (v) at least one inorganic secondary colorant selected from the group consisting of iron(III) oxide, carbon black, titanium dioxide and mixtures thereof, wherein the combined amounts of components (iii), (iv) and (v) are those amounts effective to provide a formed article with a delta L* value of less than plus/minus 0.6 measured with specular component excluded and a delta E value of less than plus/minus 1.0 after exposure of the formed article to 2500 kilojoules per square meter under accelerated weathering conditions administered under the ASTM G155c protocol, and wherein wt. % values are based on the weight of resinous components (i) and (ii); which process comprises the steps of (A) preparing a masterbatch comprising all or a portion of mica component (iii) and at least a portion of the rigid thermoplastic polymer (ii), (B) combining the masterbatch with remaining compositional components in a compounding process, (C) compounding the mixture, and optionally (D) isolating the compounded resinous composition.

Compositions of the invention and articles made therefrom may be prepared by known thermoplastic processing techniques. Known thermoplastic processing techniques which may be used include, but are not limited to, extrusion, calendering, kneading, profile extrusion, sheet extrusion, coextrusion, molding, extrusion blow molding, thermoforming, compression molding, injection molding, co-injection molding and rotomolding. The invention further contemplates additional fabrication operations on said articles, such as, but not limited to, welding, machining, in-mold decoration, baking in a paint oven, surface etching, lamination, and/or thermoforming. Compositions of the invention may also comprise regrind or reworked resinous components.

Articles comprising a composition of the invention are also embodiments of the present invention. Illustrative articles comprise those which require resistance to weathering such as articles used in outdoor applications and/or in applications where the article is exposed to sunlight. Such articles include, but are not limited to, those which are prepared by an injection molding process or profile extrusion or sheet extrusion process. In some embodiments the articles may comprise multilayer articles comprising at least one layer comprising a composition of the present invention. In various embodiments multilayer articles may comprise a cap-layer comprising a composition of the invention and a substrate layer comprising at least one thermoplastic resin different from said cap-layer. Multilayer articles comprising a cap-layer comprised of a composition of the present invention may exhibit improved weatherability compared to similar articles without said cap-layer. In other embodiments the articles consist essentially of a composition of the invention. Articles comprising compositions of the present invention include, but are not limited to, sheet, pipe capstock, hollow tubes, solid round stock, square cross-section stock, and the like. More complex shapes can also be made, such as those used for building and construction applications, especially a window frame, a sash door frame, pricing channels, corner guards, house siding, gutters, handrails, down-spouts, fence posts, and the like. Illustrative articles comprising a composition of the invention may also comprise electrical enclosures, parts and housing used in heating, ventilating, and air conditioning applications, air filter housings, parts used in telecommunication applications, parts used in lawn and garden applications, electrical components, appliance components and housings, washing machine components and housings, dishwasher components and housings, refrigerator components and housings, network enclosures, parts and housing used in personal protection and alarm systems, parts and housing used in ATM and ticket machine applications, parts and housing used in computer and consumer electronic applications, copier covers, printer covers, server bezels, gas detector parts and enclosures, and the like.

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

ASA employed in the following examples was typically an acrylate-modified ASA comprising structural units derived from 28-34 wt. % styrene, 10-15 wt. % acrylonitrile, 10-15 wt. % methyl methacrylate, and about 40-45 wt. % butyl acrylate with broad monomodal rubber particle size distribution. MMASAN was derived from about 30-45 wt. % methyl methacrylate, 35-50 wt. % styrene and 20-35 wt. % acrylonitrile. Iron oxide-coated mica (referred to sometimes herein after as “Mica-1”) was IRIODIN® 500 mica obtained from Merck. In some comparative examples titanium oxide-coated mica (referred to sometimes herein after as “Mica-2”) was IRIODIN® 100 mica available from Merck. The terms “discoloration” and “color shift” are synonymous as used herein.

Compositions were formed into sheet test samples or into injected molded test samples. Accelerated weathering measurements were typically performed under the ASTM G155c protocol. The samples were placed in a Ci65A weatherometer for accelerated weathering and were typically examined for color change at exposure times of 625, 1250, 1875, 2500, 3750 and 5000 kilojoules per square meter (kJ/m²). Samples removed at specific exposure times were evaluated visually “as is” (i.e. no wash, no polish), and color was measured using a Macbeth ColorEye® 7000A spectrophotometer with evaluation test conditions: DREOLL; D65 Illuminate; CIE LAB Equations; 10 degree Observer; reflectance mode; Specular Component Excluded (SCE); UV Excluded; Large view Port.

### EXAMPLES 1-6

Resinous compositions comprising 35 wt. % ASA and 65 wt. % MMASAN were compounded with the additives shown in Table 1. Additives comprised a mixture of organic colorants (abbreviated “Org.Col.”) and a mixture of inorganic colorants comprising carbon black and iron(III) oxide (abbreviated “Inorg.Col.”). The amounts of additives in Table 1 are expressed in parts per hundred parts resinous components (phr). Iron oxide-coated mica was combined with the other components in the form of a masterbatch extrudate with a portion of MMASAN (30 wt. % mica/70 wt. % MMASAN). The amount of mica shown in the table represents the actual amount of mica in the composition. The total amount of MMASAN in the composition includes that amount of MMASAN derived from the masterbatch. In addition each composition contained about 2.9 parts per hundred parts resinous components (phr; wherein resinous components comprise ASA and MMASAN) of a mixture of UV absorbers, antioxidants, lubricants and stabilizers. The compounded material was molded into test parts and the parts were tested for color stability under accelerated weathering conditions. The test results are shown in Table 2.

TABLE 1

| Component | Ex. 1 | Ex. 2 | Ex. 3 | Ex. 4 | Ex. 5 | Ex. 6 |
|---|---|---|---|---|---|---|
| Mica-1 | 4 | 2 | 1.5 | 4 | 2 | 1.5 |
| Org. Col. | 0.076 | 0.022 | 0.016 | 0.056 | 0.006 | 0.052 |
| Inorg. Col. | 0.40 | 0.40 | 0.30 | 0.1 | 0.45 | 0.04 |

TABLE 2

| | Ex. 1 | Ex. 2 | Ex. 3 | Ex. 4 | Ex. 5 | Ex. 6 |
|---|---|---|---|---|---|---|
| Delta L* | | | | | | |
| 625 kJ/m² | −1.4 | −1.0 | −1.2 | −1.4 | −1.0 | −1.0 |
| 1250 | −0.7 | 0 | 0 | −0.2 | −0.7 | +0.1 |
| 1875 | −0.1 | +0.2 | +0.2 | +0.2 | 0 | +0.4 |
| 2500 | −0.2 | +0.2 | −0.1 | 0 | −0.2 | 0 |
| Delta a* | | | | | | |
| 625 kJ/m² | +0.6 | +0.5 | +0.5 | +0.1 | +0.7 | +0.1 |
| 1250 | +0.4 | +0.1 | +0.1 | −0.1 | +0.4 | −0.1 |
| 1875 | +0.3 | +0.2 | +0.2 | −0.2 | +0.3 | −0.2 |
| 2500 | +0.3 | +0.3 | +0.3 | −0.2 | +0.3 | −0.2 |
| Delta b* | | | | | | |
| 625 kJ/m² | +0.7 | +0.4 | +0.7 | +0.1 | +0.8 | −0.2 |
| 1250 | +0.5 | −0.2 | +0.4 | −0.2 | +0.5 | −0.2 |
| 1875 | +0.2 | 0 | +0.2 | −0.2 | +0.2 | −0.3 |
| 2500 | +0.5 | +0.4 | +0.6 | +0.1 | +0.4 | −0.1 |
| Delta E | | | | | | |
| 625 kJ/m² | +1.7 | +1.2 | +1.5 | +1.5 | +1.5 | +1.0 |
| 1250 | +0.9 | +0.2 | +0.3 | +0.9 | +0.9 | +0.3 |
| 1875 | +0.3 | +0.3 | +0.3 | +0.3 | +0.3 | +0.5 |
| 2500 | +0.5 | +0.5 | +0.7 | +0.2 | +0.6 | +0.2 |

Examples of the invention comprising Mica-1 show good color stability under accelerated weathering conditions. In particular, the values for Delta a* show that the examples do not discolor in the red/green direction under accelerated weathering conditions. Also, the values for Delta b* show that the examples do not discolor in the yellow/blue direction under accelerated weathering conditions. In addition, the overall discoloration under accelerated weathering conditions, as represented by Delta E values, is minimal in examples of the invention. The presence of inorganic colorant iron(III) oxide in the compositions does not have a significant positive effect for preventing discoloration under accelerated weathering conditions.

### EXAMPLES 7-8 AND COMPARATIVE EXAMPLES 1-5

Resinous compositions comprising 35 wt. % ASA and 65 wt. % MMASAN were compounded with the additives shown in Table 3. Additives comprised a mixture of organic colorants (abbreviated “Org.Col.”) and a mixture of inorganic colorants comprising titanium dioxide, carbon black and iron(III) oxide (abbreviated “Inorg.Col.”). The amounts of additives in Table 3 are expressed in parts per hundred parts resinous components (phr). Examples of the invention comprised Mica-1; comparative examples (abbreviated “C.Ex.”) comprised Mica-2. Mica was combined with the other components in the form of a masterbatch extrudate with a portion of MMASAN (30 wt. % mica/70 wt. % MMASAN). The amount of mica shown in the table represents the actual amount of mica in the composition. The total amount of MMASAN in the composition includes that amount of MMASAN derived from the masterbatch. In addition each composition contained about 2.9 parts per hundred parts resinous components (phr; wherein resinous components comprise ASA and MMASAN) of a mixture of UV absorbers, antioxidants, lubricants and stabilizers. Test parts of compounded material were tested for color stability under accelerated weathering conditions. The test results are shown in Table 4.

TABLE 3

| Compo- | | | | | | | |
|---|---|---|---|---|---|---|---|
| nent | Ex. 7 | Ex. 8 | C. Ex. 1 | C. Ex. 2 | C. Ex. 3 | C. Ex. 4 | C. Ex. 5 |
| Mica-1 | 1.5 | 4 | — | — | — | — | — |
| Mica-2 | — | — | 4 | 1.5 | 1.5 | 0.5 | 0.5 |
| Org. Col. | 0.045 | 0.045 | 1.52 | 0.94 | 0.32 | 0.57 | 0.30 |
| Inorg. | 1.34 | 0.68 | 0.06 | 0.15 | 1.19 | 0.58 | 1.01 |
| Col. | | | | | | | |

TABLE 4

| | | | | | | | C. |
|---|---|---|---|---|---|---|---|
| | Ex. 7 | Ex. 8 | C. Ex. 1 | C. Ex. 2 | C. Ex. 3 | C. Ex. 4 | Ex. 5 |
| Delta L* | | | | | | | |
| 625 kJ/m² | −1.1 | −1.0 | +0.1 | +0.1 | −0.1 | −0.4 | −0.6 |
| 1250 | 0 | −0.1 | +3.1 | +2.7 | +1.6 | +0.8 | +1.6 |
| 1875 | 0 | 0 | +4.7 | +3.4 | +1.6 | +1.3 | +2.0 |
| 2500 | −0.4 | +0.2 | +4.7 | +3.6 | +1.8 | +0.7 | +1.7 |
| Delta a* | | | | | | | |
| 625 kJ/m² | +0.4 | +0.3 | −1.4 | −0.5 | +0.1 | −0.1 | +0.7 |
| 1250 | 0 | 0 | −2.9 | −1.6 | −0.5 | −0.3 | −0.2 |
| 1875 | 0 | 0 | −4.0 | −2.1 | −0.2 | 0 | +0.1 |
| 2500 | +0.2 | 0 | −5.0 | −2.8 | −0.1 | 0 | +0.4 |
| 5000 | +0.5 | +0.3 | — | — | +1.1 | — | — |
| Delta b* | | | | | | | |
| 625 kJ/m² | +0.5 | +0.5 | −0.9 | −0.7 | +0.1 | 0 | 0 |
| 1250 | −0.3 | −0.2 | −1.1 | −1.1 | −0.3 | +0.1 | −0.5 |
| 1875 | −0.2 | −0.2 | −1.6 | −1.3 | 0 | +0.3 | −1.0 |
| 2500 | +0.3 | −0.1 | −1.5 | −1.3 | +0.5 | +1.0 | −1.0 |
| 5000 | +0.7 | +0.2 | — | — | +2.9 | — | — |
| Delta E | | | | | | | |
| 625 kJ/m² | +1.1 | +1.1 | +1.7 | +0.9 | +0.2 | +0.4 | +0.9 |
| 1250 | +0.2 | +0.2 | +4.2 | +3.2 | +1.7 | +0.9 | +1.7 |
| 1875 | +0.2 | +0.2 | +6.2 | +4.0 | +1.6 | +1.4 | +2.2 |
| 2500 | +0.5 | +0.2 | +7.0 | +4.3 | +1.9 | +1.2 | +2.0 |
| 5000 | +1.7 | +1.0 | — | — | +3.2 | — | — |

Compositions of the invention comprising Mica-1 show less discoloration under accelerated weathering conditions than comparative compositions comprising Mica-2. More particularly, the data in Table 4 show that values for Delta L* are improved in compositions of the invention comprising Mica-1 versus Delta L* values for compositions in comparative examples comprising Mica-2. Decreasing the amount of Mica-2 in compositions of the comparative examples (comparative example 1 vs. comparative examples 2-5) leads to some improvement in Delta L* values but said values are still not as good as those observed for examples 7-8 of the invention.

In addition, the data in Table 4 show that values for Delta a* are typically improved in compositions of the invention comprising Mica-1 versus Delta a* values for compositions in comparative examples comprising Mica-2. Compositions of comparative examples comprising Mica-2 show significant discoloration as represented by Delta a* values except at the lowest levels of Mica-2. Decreasing the amount of Mica-2 in compositions of the comparative examples (comparative example 1 vs. comparative examples 2-3) leads to some improvement in Delta a* values but said values are still not as good as or are no better than those observed for examples 7-8 of the invention.

In addition, the data in Table 4 show that values for Delta b* are improved in compositions of the invention comprising Mica-1 versus Delta b* values for compositions in comparative examples comprising Mica-2. Compositions of comparative examples comprising Mica-2 show significant discoloration as represented by Delta b* values. Decreasing the amount of Mica-2 in compositions of the comparative examples (comparative example 1 vs. comparative examples 2-5) leads to some improvement in Delta b* values but said values are still not as good as those observed for examples 7-8 of the invention.

In addition, the data in Table 4 show that the overall color shift, as represented by Delta E values, is less in examples of the invention comprising Mica-1 than in comparative examples comprising Mica-2. Compositions of comparative examples comprising Mica-2 show significant discoloration as represented by Delta E values. Decreasing the amount of Mica-2 in compositions of the comparative examples (comparative example 1 vs. comparative examples 2-5) leads to some improvement in Delta E values but said values are still not as good as those observed for examples 7-8 of the invention. Decreasing the amount of organic colorant in compositions of the comparative examples leads to some improvement in Delta E values but said values are still not as good as those observed for examples 7-8 of the invention.

### COMPARATIVE EXAMPLES 6-10

Resinous compositions comprising 35 wt. % ASA and 65 wt. % MMASAN were compounded with the additives shown in Table 5. Additives comprised a mixture of organic colorants (abbreviated “Org.Col.”) and a mixture of inorganic colorants comprising titanium dioxide, carbon black and iron(III) oxide (abbreviated “Inorg.Col.”). The amounts of additives in Table 5 are expressed in parts per hundred parts resinous components (phr). Comparative examples (abbreviated “C.Ex.”) comprised Mica-2. Mica-2 was combined with the other components in the form of a masterbatch extrudate with a portion of MMASAN (30 wt. % mica/70 wt. % MMASAN). The amount of mica shown in the table represents the actual amount of mica in the composition. The total amount of MMASAN in the composition includes that amount of MMASAN derived from the masterbatch. In addition each composition contained about 2.9 parts per hundred parts resinous components (phr; wherein resinous components comprise ASA and MMASAN) of a mixture of UV absorbers, antioxidants, lubricants and stabilizers. Test parts of compounded material were tested for color stability under accelerated weathering conditions. The test results are shown in Table 6.

TABLE 5

| Component | C. Ex. 6 | C. Ex. 7 | C. Ex. 8 | C. Ex. 9 | C. Ex. 10 |
|---|---|---|---|---|---|
| Mica-2 | 4 | 2.1 | 2.1 | 1.5 | 1.5 |
| Org. Col. | 1.53 | 1.53 | 1.02 | 0.96 | 0.94 |
| Inorg. Col. | 0.06 | 0.06 | 0.81 | 1.06 | 0.03 |

TABLE 6

| | C. Ex. 6 | C. Ex. 7 | C. Ex. 8 | C. Ex. 9 | C. Ex. 10 |
|---|---|---|---|---|---|
| Delta L* | | | | | |
| 625 kJ/m² | +0.1 | +0.1 | −0.3 | −0.4 | +0.1 |
| 1250 | +3.1 | +2.6 | +2.3 | +1.4 | +2.7 |
| 1875 | +4.7 | +3.8 | +2.5 | +2.2 | +3.4 |
| 2500 | +4.7 | +4.0 | +2.5 | +1.8 | +3.6 |
| Delta a* | | | | | |
| 625 kJ/m² | −1.4 | −1.2 | −0.1 | +0.2 | −0.4 |
| 1250 | −2.9 | −2.3 | −0.9 | −0.3 | −1.7 |
| 1875 | −4.0 | −3.9 | −1.0 | −0.3 | −2.1 |
| 2500 | −4.9 | −4.1 | −1.0 | −0.3 | −2.8 |
| Delta b* | | | | | |
| 625 kJ/m² | −0.9 | −0.3 | −0.1 | +0.2 | −0.7 |
| 1250 | −1.1 | −0.4 | −0.1 | +0.7 | −1.1 |
| 1875 | −1.6 | −0.4 | −0.6 | −0.1 | −1.3 |
| 2500 | −1.5 | −0.5 | −0.5 | −0.1 | −1.3 |
| Delta E | | | | | |
| 625 kJ/m² | +1.7 | +1.3 | +0.2 | +0.4 | +0.9 |
| 1250 | +4.2 | +3.5 | +2.4 | +1.6 | +3.2 |
| 1875 | +6.2 | +5.4 | +2.8 | +2.1 | +4.0 |
| 2500 | +7.0 | +5.9 | +2.8 | +1.8 | +4.3 |

The data in Table 6 show that all the comparative examples comprising Mica-2 discolor under accelerated weathering conditions and that the discoloration is greater than any discoloration exhibited by examples of the invention comprising Mica-1 in Tables 2 and 4. Decreasing the amount of Mica-2 results in decreased discoloration under accelerated weathering conditions (C.Ex.6 vs. other comparative examples). Among this set of comparative examples in Tables 5-6, some improvement in color stability is observed in comparative examples which further comprise iron(III) oxide. However, as shown in Tables 1-2 the presence of iron(III) oxide is not necessary to improve resistance to discoloration in examples of the invention comprising Mica-1. Therefore, in some embodiments of the invention the compositions do not contain iron(III) oxide added in the form of inorganic colorant separate from iron oxide-coated mica.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All Patents and published articles cited herein are incorporated herein by reference.

1. A weatherable, colored resinous composition comprising (i) 25-45 wt. % of an acrylonitrile-styrene-acrylate graft copolymer (ASA) or acrylate-modified ASA, (ii) 75-55 wt. % of at least one rigid thermoplastic polymer comprising structural units derived from styrene and acrylonitrile; alpha-methylstyrene and acrylonitrile; alpha-methylstyrene, styrene, and acrylonitrile; styrene, acrylonitrile, and methyl methacrylate; alpha-methyl styrene, acrylonitrile, and methyl methacrylate; or alpha-methylstyrene, styrene, acrylonitrile, and methyl methacrylate, or mixtures thereof, (iii) at least one iron oxide-coated mica, and (iv) at least one organic or inorganic secondary colorant, wherein the combined amounts of components (iii) and (iv) are those amounts effective to provide a formed article with a delta L* value of less than plus/minus 0.6 measured with specular component excluded and a delta E value of less than plus/minus 1.0 after exposure of the formed article to 2500 kilojoules per square meter under accelerated weathering conditions administered under the ASTM G155c protocol, and wherein wt. % values are based on the weight of resinous components (i) and (ii).

2. The weatherable, colored resinous composition of claim 1, wherein the rigid thermoplastic polymer (ii) comprises structural units derived from styrene, acrylonitrile and methyl methacrylate.

3. The weatherable, colored resinous composition of claim 1, wherein the iron oxide-coated mica is present in an amount in a range of 0.1 parts per hundred parts resin (phr) and 10 phr.

4. The weatherable, colored resinous composition of claim 1, wherein the iron oxide-coated mica is present in an amount in a range of 0.3 phr and 6 phr.

5. The weatherable, colored resinous composition of claim 1, comprising at least one organic secondary colorant and at least one inorganic secondary colorant, wherein the inorganic colorant is selected from the group consisting of iron(III) oxide, carbon black, titanium dioxide and mixtures thereof.

6. The weatherable, colored resinous composition of claim 1, comprising at least two organic secondary colorants and at least one inorganic secondary colorant, wherein the inorganic colorant is selected from the group consisting of iron(III) oxide, carbon black, titanium dioxide and mixtures thereof.

7. The weatherable, colored resinous composition of claim 1, further comprising at least one additive selected from the group consisting of lubricants, stabilizers, heat stabilizers, light stabilizers, antioxidants, UV screeners, UV absorbers, and mixtures thereof.

8. The weatherable, colored resinous composition of claim 1, wherein all or a portion of the mica component (iii) is combined with the composition in the form of a masterbatch with at least a portion of the rigid thermoplastic polymer (ii).

9. An article made from the composition of claim 1.

10. An article made from the composition of claim 5.

11. An article made from the composition of claim 7.

12. A weatherable, colored resinous composition comprising (i) 25-45 wt. % of an acrylonitrile-styrene-acrylate graft copolymer (ASA) or acrylate-modified ASA, (ii) 75-55 wt. % of at least one rigid thermoplastic polymer comprising structural units derived from styrene, acrylonitrile, and methyl methacrylate, (iii) at least one iron oxide-coated mica present in an amount in a range of 0.1 parts per hundred parts resin (phr) and 10 phr, (iv) at least one organic secondary colorant and (v) at least one inorganic secondary colorant selected from the group consisting of iron(III) oxide, carbon black, titanium dioxide and mixtures thereof, wherein the combined amounts of components (iii), (iv) and (v) are those amounts effective to provide a formed article with a delta L* value of less than plus/minus 0.6 measured with specular component excluded and a delta E value of less than plus/minus 1.0 after exposure of the formed article to 2500 kilojoules per square meter under accelerated weathering conditions administered under the ASTM G155c protocol, and wherein wt. % values are based on the weight of resinous components (i) and (ii).

13. The weatherable, colored resinous composition of claim 13, further comprising at least one additive selected from the group consisting of lubricants, stabilizers, heat stabilizers, light stabilizers, antioxidants, UV screeners, UV absorbers, and mixtures thereof.

14. An article made from the composition of claim 12.

15. An article made from the composition of claim 13.

16. A process for preparing a weatherable, colored resinous composition comprising (i) 25-45 wt. % of an acrylonitrile-styrene-acrylate graft copolymer (ASA) or acrylate-modified ASA, (ii) 75-55 wt. % of at least one rigid thermoplastic polymer comprising structural units derived from styrene and acrylonitrile; alpha-methylstyrene and acrylonitrile; alpha-methylstyrene, styrene, and acrylonitrile; styrene, acrylonitrile, and methyl methacrylate; alpha-methyl styrene, acrylonitrile, and methyl methacrylate; or alpha-methylstyrene, styrene, acrylonitrile, and methyl methacrylate, or mixtures thereof, (iii) at least one iron oxide-coated mica, (iv) at least one organic secondary colorant and (v) at least one inorganic secondary colorant selected from the group consisting of iron(III) oxide, carbon black, titanium dioxide and mixtures thereof, wherein the combined amounts of components (iii), (iv) and (v) are those amounts effective to provide a formed article with a delta L* value of less than plus/minus 0.6 measured with specular component excluded and a delta E value of less than plus/minus 1.0 after exposure of the formed article to 2500 kilojoules per square meter under accelerated weathering conditions administered under the ASTM G155c protocol, and wherein wt. % values are based on the weight of resinous components (i) and (ii);
which process comprises the steps of (A) preparing a masterbatch comprising all or a portion of mica component (iii) and at least a portion of the rigid thermoplastic polymer (ii), (B) combining the masterbatch with remaining compositional components in a compounding process, and (C) compounding the mixture.

17. The process of claim 16, wherein the rigid thermoplastic polymer (ii) comprises structural units derived from styrene, acrylonitrile and methyl methacrylate.

18. The process of claim 16, wherein the iron oxide-coated mica is present in an amount in a range of 0.1 parts per hundred parts resin (phr) and 10 phr.

19. The process of claim 16, wherein the composition further comprises at least one additive selected from the group consisting of lubricants, stabilizers, heat stabilizers, light stabilizers, antioxidants, UV screeners, UV absorbers, and mixtures thereof.
